(19) United States
(12) Patent Application Publication
(10) Pub. No.: US 2009/0304861 A1
(43) Pub. Date: Dec. 10, 2009

(54) LEAVENED PRODUCTS MADE FROM NON-WHEAT CEREAL PROTEINS

(76) Inventors: Bruce R. Hamaker, West Lafayette, IN (US); Carla D. Mejia, West Lafayette, IN (US); Lisa J. Mauer, West Lafayette, IN (US); Osvaldo H. Campanella, West Lafayette, IN (US)

Correspondence Address: GREENLEE WINNER AND SULLIVAN P C, 4875 PEARL EAST CIRCLE, SUITE 200, BOULDER, CO, 80301, US

(21) Appl. No.: 12/441,656

(22) PCT Filed: Sep. 18, 2007
(86) PCT No.: PCT/US07/78750

§ 371 Date: Jul. 21, 2009

Related U.S. Application Data
(60) Provisional application No. 60/845,404, filed on Sep. 18, 2006.

(51) Int. Cl. A21D 13/00; A21D 2/26; A23J 1/20; A21D 10/00; A21D 8/00; A21D 2/34; A21D 2/38

(52) U.S. Cl. 426/18; 426/656; 426/657; 426/549; 426/551; 426/496

(57) ABSTRACT

Gluten-free baked products, particularly gluten-free bread products, which exhibit properties comparable those made with wheat flour. Compositions and methods for preparation of gluten-free baked products. A conditioned protein or protein composite which functions to replace gluten in gluten-free flour. The conditioned protein comprises one more non-wheat cereal storage proteins, particularly prolamins, optionally, but preferably in combination with one or more co-proteins which function to facilitate formation and stabilize formation of a protein network, e.g., β-sheet network, that facilitates retention of CO₂ for leavening. More specifically, protein composites of zein and or other non-wheat prolamins with co-proteins including casein, elastin or mixtures thereof conditioned at temperatures above the glass transition temperature of the protein mixture provide improved ingredients for preparation of gluten-free breads and other baked products. Sorghum or maize mutant flours with prolamins available for viscoelastic protein formation may also be used.

### CROSS-REFERENCE TO RELATED APPLICATIONS

This application takes priority from U.S. provisional application 60/845,404, filed Sep. 18, 2006 which is incorporated by reference herein in its entirety.

### BACKGROUND OF THE INVENTION

Wheat gluten forms viscoelastic networks able to retain CO₂ produced from yeast fermentation that allows for the production of leavened baked products. Schofield, J. D. Wheat proteins: structure and functionality in milling and breadmaking. In: Bushnuk, W., Rasper, V. F. (Eds.), Wheat Production, Properties and Quality. Chapman & Hall, London, pp 743-806 (1994), and Shewry, P. R., Halford, N. G., Belton, P. S., Tatham, A. S. The structure and properties of gluten an elastic protein from wheat grain. Philos. Trans R Soc London, Ser. B. 357, 133-142 (2002). Wheat gluten is considered the only protein, cereal-based or otherwise, with the proper functionality to produce high quality breads and associated products. Currently, there are no known protein substitutes for wheat gluten to make leavened baked products. Gluten-free breads, which are currently available, are made using polysaccharide-based gums and other additives and are generally of poor quality compared to wheat-based breads. For example, gluten-free breads have been made by replacing traditional wheat flour by potato, corn or similar flour and adding a thickening viscoelastic agent and an emulsifier to enable the bread to retain gas issuing from fermentation of the yeast to be retained and thus create a cell-like internal structure composed of a large number of gaseous cells of small size.

Recent reports estimate about 1 in 125 people have some degree of wheat intolerance with concentration in populations in North America and Europe. In particular, those suffering from celiac disease exhibit intolerance to gluten. Although new therapeutic options for those with celiac disease have been developed, patients must still be on a life-long gluten-free diet in order to control symptoms associated with the disease. Poor patient compliance due mostly to the lack of healthy diet alternatives to wheat-based leavened products is a continuing problem. Thus, there is a need for a gluten replacement viscoelastic protein for use in making gluten-free baked goods for such wheat-intolerant individuals.

Consumer demand for leavened products in tropical and sub-tropical countries is currently met by importation of large amounts of wheat. A gluten replacement will provide alternatives to satisfy this consumer demand. It would be particularly beneficial to develop products and processes which use a non-wheat cereal protein for making bread and other leavened baked goods of quality comparable to wheat-based breads and baked goods.

The present invention provides non-wheat gluten replacements that provide dough with viscoelasticity to contain CO₂ from yeast fermentation and which yield leavened baked products much like wheat-based bread. The non-wheat gluten replacement of this invention relies on the use of non-wheat cereal storage proteins (e.g., from corn, rice, sorghum, millet, etc.). The invention covers both isolated non-wheat cereal protein that can be mixed with a starch-based carrier or non-wheat flour, or the direct use of certain cereal flour replacements whereby the storage protein is available to interact and form the necessary viscoelastic gluten-like fibrils. The use of such cereal flour replacements would improve markets for locally grown grains and act to stimulate local economies.

Gluten-free breads and baked products are known in the art. For example, U.S. Pat. No. 4,451,491 relates to a mix for the preparation of bread and cake products comprising a non-wheat-based starch, a gluten-substitute gum, an emulsified-fat powdered whipping agent and optionally comprising a binding agent. The non-wheat-based starch is exemplified by corn flour, rice flour, soybean flour, potato flour, tapioca flour, cassava flour, sweet potato flour and yam. The gluten-substitute gum is exemplified by xanthan gum, guar gum, locust-bean gum, alginate, pregelatinized starch and carboxymethylcellulose. The emulsified-fat powdered whipping agent is exemplified by spray dried margarine, spray dried butter, spray dried cream, vegetable lipid whipping agents and combinations thereof. The binding agent is exemplified by gelatin, instant gelatin, agar agar and carrageenen.

U.S. Pat. No. 3,676,150 relates to a low calorie leavened bread which contains no wheat flour wherein the gluten-free flour comprises α-cellulose, edible starch and a cellulose gum. The edible starch is exemplified as wheat starch or corn starch. The cellulose gum is exemplified as hydroxypropylmethyl cellulose, sodium carboxymethyl cellulose or mixtures thereof.

Various proteins have been added to wheat flour bread to improve its nutritional content. For example, milk, typically non-fat dry milk (NFDM), has been incorporated into bread to enhance its nutritional value due to its protein content (casein and the whey proteins.)

U.S. Pat. No. 5,178,894 relates to compositions for making high non-fat milk content bread products containing wheat flour and about 24% to about 48% by weight/100 parts wheat flour of high heat non-fat dry milk solids. The bread product is reported to have increased protein and calcium content, improved keeping qualities and improved flavor and organoleptic properties. The compositions may also contain vegetable gums such as guar gum, carrageenan, algins, karaya gum or mixtures thereof to improve loaf volume.

As discussed in U.S. Pat. No. 5,178,894, it has been reported in U.S. Pat. No. 3,411,919 that whey proteins have a deleterious effect on bread structure and loaf volume, so that NFDM used must be heat treated (high heat NFDM) to denature whey proteins. “High heat” NFDM, which is used in yeast leavened bake goods, is described in U.S. Pat. No. 4,395,426 as milk that has been subjected to temperatures higher than normal pasteurization temperatures prior to drying to partially denature the milk proteins. U.S. Pat. No. 5,178,894 further states that “it is generally accepted that the amount of NFDM should not exceed 8.2%, and usually not more than 6%, based upon the flour weight if satisfactory loaf volume is to be maintained, referring to “Baking Production Technology,” American Institute of Baking, Baltimore, Md., Conference of Nov. 7-9, 1988.

U.S. Pat. No. 4,395,426 relates to a dry mix process for preparing bread without a kneading step. The bread optionally contains 1 to 10 parts by weight per 100 parts flour of high heat non-fat dry milk solids (NFDM). The bread also contains about 0.5 to 1.5 parts by weight per 100 parts of flour of a propylene glycol alginate and about 2 parts to 10 parts of a gum, such as karaya gum, guar gum, xanthan gum, high viscosity carboxymethyl cellulose, high viscosity carrageenan gum and mixtures thereof.

U.S. Pat. No. 3,121,013 and U.S. Pat. No. 3,411,919, which is also discussed in U.S. Pat. No. 5,178,894, relate to improved compositions for making continuous-mix wheat flour breads which contain 2-6% NFDM to improve its flavor. U.S. Pat. No. 3,411,919 reports that it was known prior to their improvement that use of levels of NFDM exceeding 1% of the flour weight in the continuous-mix process led to significant reduction in bread volume and deterioration of loaf shape, with weakened side walls. These two patents report that the level of NFDM can be increased in the continuous-mix process to improve flavor without loss of volume or structure by addition of hydroxylated phosphatide (e.g., lecithin) alone or in combination with carrageenan. U.S. Pat. No. 3,271,164, also discloses a continuous process of bread making in which the dough contains (based on wheat flour weight) about 4% of NFDM along with 0.1% to 0.9% karaya gum and from about 0.02% to about 0.1% of algins and/or carrageenans.

Dotsenko et al., Pishchevaya Primyshlennost, 1, 32-33 (1987), is described in U.S. Pat. No. 5,178,894 as “using NFDM in amounts from 10-15%, based on the wheat flour weight, together with monoglyceride esters of diacetyl tartaric acid and the multi-enzyme complex MFK-KhP to hydrolyze the NFDM.” The resulting doughs are described as showing improved rheological properties and binding capacities.

U.S. Pat. No. 7,083,816 relates to the use of modified whey in bread-making to provide slowing of staling of the bread product. Whey is modified by removal of lactose and hydrolysis with lactase to reduce the lactose level to between 10 and 50% by weight of the quantity of lactose initially present in the unmodified whey, by adding a calcium trap to the whey, followed by hydrolysis by at least one endopeptidase, at least one exopeptidase and at least one molecule capable of cutting the disulfide bridges until a level of total proteins is at most 80% by weight of the initial weight of proteins present in the unmodified initial whey. The treated whey is then further treated to inactivate all the enzymes present. Use of the modified whey in bread dough is reported to improve dough smoothness, softness and water-retention.

U.S. Pat. No. 5,976,598 relates to particular cellulosic material physically coated with an edible hydrophobic polymer to provide a low calorie flour/starch replacement. Hydrophobic polymers include among others proteins, such as zein and glutenin.

Lawton, J. W., 1992. Viscoelasticity of zein-starch doughs. Cereal Chemistry 69, 351-355 reports that zein-starch composite flour can be mixed into doughs that are viscoelastic and similar to those prepared from wheat flour. The composite flour was reported not to develop into dough, unless mixed below the glass transition temperature of zein. Dough which was rested and cooled to below the glass transition temperature of zein was reported to lose viscoelasticlty. At temperatures above its glass transition temperature, zein was reported to form fibers during mixing, similar in appearance to those formed from wheat glutenin which appear responsible for the observed viscoelasticity of the zein-starch doughs. Addition of the plasticizer, dibutyl tartrate, to the zein starch mixture was reported not to be needed to form the viscoelastic doughs. The reference does not report that the zein-starch doughs were useful for making leavened bread or other leavened baked products.

Bugusu, B. A., Campanella, O., Hamaker, B. R., 2001. Improvement of sorghum-wheat composite rheological properties and breadmaking quality through zein addition. Cereal Chemistry 78, 31-35 reports that that the addition of protein body-free α-zein (<2% of total flour weight) at 35° C. improved the rheological and leavening characteristics of a wheat-sorghum composite (80:20) flour dough and bread. Given the high degree of homology between zein and kafirin (DeRose et al., 1989), the authors suggested that zein, and probably kafirin, if freed from the confines of their protein bodies, could improve the poor functionality of wheat-sorghum composite flour dough.

### SUMMARY OF THE INVENTION

The invention relates to gluten-free flours, dough and food products, particularly leavened baked goods and breads, prepared using the flour. The invention further relates to methods for making dough and leavened baked products which are gluten-free.

An embodiment of the invention provides changing the structure of a non-wheat cereal prolamin or other storage protein, particularly zein or kafirin, to allow the formation of a protein network comparable to that of wheat gluten, which is viscoelastic, that can resist stress caused by mixing, and is able to entrap CO₂ from the yeast fermentation process during dough proofing. As a result of this structural change to the non-wheat cereal prolamin or other storage protein, leavened baked products, namely breads and associated products, can be manufactured. These gluten-free products can be used as a replacement for wheat bread for patients who suffer from allergies or intolerance to gluten (celiac disease), as well as those desiring new bread-type products.

In one embodiment, the invention relates to the use of non-wheat cereal storage proteins, particularly non-wheat cereal prolamins, to prepare dough and leavened baked products. In this embodiment, a non-wheat cereal protein conditioned at a temperature above its glass transition temperature in a moistened system is employed to provide the viscoelasticity needed to replace gluten functionality in a leavened dough. In particular non-wheat cereal prolamins and more particularly corn zein, when conditioned above the protein's glass transition temperature in a moistened system, exhibit viscoelastic properties and can be used to prepare leavened dough which entrap CO₂ from yeast fermentation which on baking results in non-wheat baked products that exhibit quality comparable to wheat gluten-based products.

In another embodiment, the invention relates to the use of non-wheat cereal storage proteins, particularly non-wheat prolamins, in combination with a co-protein to prepare dough and leavened baked products. In general the co-protein is any animal or plant protein that can cross-link to stablize beta-sheet structure of the cereal storage protein. In specific embodiments, the use of a co-protein that is a plant protein is preferred. In this embodiment, the non-wheat protein is combined with the co-protein and the mixture is conditioned at a temperature above the glass transition temperature of the mixture in a moistened system. Dough prepared from the conditioned mixture provides the viscoelasticity needed to replace gluten functionality in a leavened dough. In particular non-wheat cereal prolamines and more particularly corn zein, combined with a small amount of co-protein that stabilizes β-sheet formation, such as casein, elastin or mixtures thereof, and conditioned above the glass transition temperature of the mixture in a moistened system, exhibit viscoelasticity properties and can be used to prepare leavened dough which entrap CO₂ from yeast fermentation which on baking results in non-wheat baked products that exhibit quality comparable to wheat gluten-based products. Co-proteins useful in the invention also include specific seed storage proteins, γ-zein and γ-zafirin.

In specific embodiments, the compositions (e.g., flours, ingredients and dough) of this invention do not require the presence of a gluten-substitute gum or vegetable gum, such as xanthan gum, guar gum, karaya gum, locust-bean gum, aligns, alginate, pregelatinized starch or carboxymethyl cellulose. Neither do the compositions of this invention require the presence of a binding agent, such as gelatin, instant gelatin, agar agar or carrageenen. The compositions further do not require cellulose gum, such as hydroxypropylmethyl cellulose, sodium carboxymethyl cellulose or mixtures thereof.

The invention provides conditioned protein (non-wheat prolamin or other cereal storage proteins or mixtures of the protein with co-protein) as a new ingredient, a gluten replacement ingredient, for making dough, dough and leavened dough made from the new ingredient, and baked products made from such dough. The invention also provides methods for preparation of dough, particularly leavened dough, from such conditioned protein and methods for making baked products, including bread and other leavened baked products.

### BRIEF DESCRIPTION OF THE DRAWINGS

FIGS. 1 and 2 show mixograph profiles of a zein-starch dough at 35° C., and wheat dough at 25° C., respectively. FIGS. 1 and 2 show similarities and differences in mixograph profiles for wheat dough at 25° C. and zein-starch at 35° C. Shorter development time and a greater resistance to sheer stress were observed in the zein-starch dough (FIG. 1) than in wheat dough (FIG. 2). Resistance to stress and viscoelasticity are lost in the zein dough when stress is removed or at room temperature. Addtion of casein or other co-protein to the zein-starch dough results in maintenance of the resistance to stress and viscoelasticity for longer periods and at room temperature.

### DETAILED DESCRIPTION OF INVENTION

The invention generally relates to the use of non-wheat prolamins or other cereal storage proteins alone or in combination with certain co-proteins as functional replacements for gluten in gluten-free flour. The invention relates to compositions comprising one or more non-wheat prolamins or other cereal storage proteins in combination with one or more co-proteins for the preparation of leavened dough for baked products, including bread, pizza and related products. The co-protein is a protein, other than a wheat protein, which stabilizes β-sheet formation in the non-wheat prolamin or other storage protein. In specific embodiments, the co-protein is a cross-linking or binding protein that stabilizes β-sheet formation in the non-wheat prolamin. In more specific embodiments, the co-protein is casein or elastin. In other specific embodiments, the co-protein is gamma-zein and analogous non-wheat cereal proteins. The invention provides improved flour and dough for making leavened baked goods. Flours and dough of this invention comprise non-wheat starch or any non-wheat flour, non-wheat prolamin or other cereal storage protein and preferably co-protein. Dough contains sufficient water or other suitable liquid to form dough of desired consistency appropriate for the desired dough application.

Prior to dough preparation, non-wheat cereal prolamin or other storage protein or mixtures of non-wheat protein and co-protein, optionally in combination with starch or flour, are conditioned in the presence of moisture at a temperature above the glass transition temperature of the prolamin/storage protein or that protein/co-protein composite. The protein or protein composite is conditioned for a sufficient time to allow change to a movable (flowable) state. In specific embodiments, the composite is conditioned for 1-36 hours and more preferably for 12-24 hours prior to dough preparation. The conditioning temperature employed depends upon the prolamin/storage protein and/or co-protein employed, but typically will range from about 25° C. to about 50° C. When zein is the non-wheat prolamin, the conditioning temperature is typically about 35° to about 50° C. The moisture content of the prolamin/storage protein or the protein/co-protein composite during conditioning is sufficient to hydrate the proteins and allow the proteins to be converted from the glassy state to a flowable state. When zein is the prolamin, the moisture content during conditioning can range typically from about 10% to about 25% by weight. In general, the moisture content during conditioning can be adjusted for the prolamin/storage protein and co-protein, but will range from 5% to about 25% (w/w).

In specific embodiments, the non-wheat prolamin/storage protein or the protein composite ranges from 5% to 25% by weight of the combined weight of starch/flour and protein and co-protein, if present, ranges from about 1% to about 20% (by weight) of the total protein and more preferably ranges from about 3 to 15% by weight of the total protein. In specific embodiments, the co-protein is present at 8-12% by weight of the total protein and in more specific embodiments at about 10% by weight of total protein and in other specific embodiments at about 3% by weight of total protein. With respect to the total dry weight of the composition, co-protein is present at levels between 0.1% to 2% of the composition (containing starch and/or flour). In specific embodiments, the co-protein is present at levels ranging from 0.3% to 1.5% by weight of the total dry composition and in other embodiments is present at 0.8 to 1.2% by weight of total compositions. In more specific embodiments, the co-protein is present at levels of 0.3% or 1% by weight of total composition.

Conditioned protein, starch/flour and other dough ingredients are combined with sufficient water or other liquid to form dough of desired consistency for a given application. One of ordinary skill in the art can readily determine the amount of moisture that is needed. When the conditioned protein does not contain co-protein, it is preferred that dough processing is also performed at a temperature above the glass transition temperature of the protein.

As will be appreciated by one of ordinary skill in the art, the compositions and dough of this invention can contain other additives, including salt, flavorings, vitamins, a source of calcium, additional non-wheat protein (e.g., soy protein) for nutritional value, preservatives, mold retardants and the like.

The term “non-wheat cereal storage protein” refers generally to the seed storage proteins of all cereals other than wheat and includes prolamins, glutelins and globulin proteins. Non-wheat cereal storage proteins, such as glutelin from rice or globulin form oats may be used in this invention.

The term “non-wheat cereal prolamin” refers generally to prolamin storage proteins of cereals other than wheat. In specific embodiments, the non-wheat prolamin is a zein (from maize), a kafirin (from sorghum), a panicin (from millet) or a oryzenin (from rice).

Maize prolamins are zeins which constitute between 44 and 79% of the corn endosperm proteins. Zeins are classified into four types: α, β, γ, and δ zeins. These protein types correspond to components with molecular weights of 22,000 and 19,000 Mr, 16,000 and 14,000 Mr, 27,000 and 50,000 Mr, and 10,000 Mr, respectively. Zeins are synthesized by membrane-bound polyribosomes and transported into the lumen of the ER, where they assemble into protein bodies of approximately 1 μm in size. The α- and δ-zeins are located in the central region of the protein bodies, and β- and γ-zeins are found in the periphery. α-Zeins account for approximately 75 to 80% of the total prolamins in maize and are the major zein found in commercial zein (Lawton, 2002). The protein is rich in glutamine, leucine, proline, alanine, and phenylalanine residues, which explains its significant hydrophobic properties. Although both groups of α-zein have slightly different molecular weight, they have similar structures, consisting of unique N- and C-terminal domains flanking repeated sequences. Although repeated domains are generally considered to contain blocks of approximately 20 residues, these blocks are highly degenerate, and do not contain a clear consensus motif. The size difference between the 19,000 and 22,000 Mr zeins may result from variation in the number of blocks present in the repetitive domains or from the insertion of a loop region of 20 residues in the C-terminal domain of the 22,000 Mr proteins. The precise structure adopted by the α-zeins is still uncertain.

Sorghum prolamins are called kafirins. Among the proteins of sorghum, kafirins are the most abundant, making up 70-80% of the total endosperm protein. They have been classified according to structure, molecular weight, and solubility characteristics into α-(Mr 25,000 and 20,000), β-(Mr 20,000, 18,000, and 16,000), and γ-kafirins (Mr 28,000). Alpha-kafirin, the main storage protein, comprises about 80% of total kafirin in the endosperm. The amino acid compositions of β- and γ-kafirin are unique because in part to their high content of Cys, which is about 5 and 7 mol %, respectively. During development, kafirins are synthesized and deposited inside the rough endoplasmic reticulum to form protein bodies. Within the protein body, the kafirins are distributed in a nonhomogeneous fashion. Alpha-kafirin is located mainly in the interior of the protein body, and β- and γ-kafirin are found in dark-staining areas inside and at the periphery of the protein body.

Sorghum protein has generally lower digestibility than protein of other cereal grains, such as wheat, maize, and rice. Recently, a sorghum mutant cultivar whose protein digestibility resembles or surpasses that of other cereals has been identified (Oria M. P., Hamaker, B. R., Axtell, J. D., Huang, C-P. “A highly digestible sorghum mutant cultivar exhibits a unique folded structure of endosperm protein bodies” (2000) Proc. Na'tl Acad Sci (US) 97(10):5065-5070). In the endosperm of this sorghum mutant cultivar α-, β-, and γ-kafirins were localized within its protein bodies. However the protein bodies had a unique microstructure compared to low protein digestibility sorghum.

The protein bodies of the mutants are irregular in shape and have numerous invaginations, often reaching to the central area of the protein body. Protein bodies from normal cultivars in contrast are spherical and contain no invaginations. In the mutant α- and β-kafirins are within the protein bodies similar to normal cultivars. The γ-kafirin, however, is concentrated in regions at the base of the folds instead of at the protein body periphery, as is typical of normal cultivars. It is reported that increased digestibility is due to the easy accessibility of digestive enzymes to α-kafirin, the major storage protein, and in addition to the increased surface area of the protein bodies of the highly digestible cultivar. Kafirins of such mutants are useful in the compositions and methods of this invention. More generally, non-wheat storage proteins of mutant plants in which the protein bodies are disrupted or in which the distribution of storage protein is distinct from that of wild-type cultivars can be used in the compositions and methods of this invention. For example, zeins or kafirins from mutant plants in which the protein bodies are disrupted or in which the protein distribution is distinct from wild-type cultivars can be more available for interaction with added co-protein.

Kafirins exhibit extensive homology with zeins (DeRose, R. T., Ma, D. P., Kwon, I. S., Hasnain, S. E., Klassy, R. C., Hall, T. C., 1989. Characterization of the kafirin gene family from sorghum reveals extensive homology with zein from maize. Plant Molecular Biolology 12, 245-256.) In specific embodiments, non-wheat prolamins having significant levels of amino acid sequence homology with zeins, particularly α-zein, are useful in the compositions and methods of this invention. More specifically, non-wheat prolamins having greater than 80% sequence homology or greater than 90% sequence homology or greater than 95% sequence homology to zeins, and particularly to α-zein, are useful in the compositions and methods of this invention. In specific embodiments, non-wheat prolamins having significant levels of amino acid sequence identity with zeins, particularly α-zein, are useful in the compositions and methods of this invention. More specifically, non-wheat prolamins having greater than 80% sequence identity or greater than 90% sequence identity or greater than 95% sequence identity to zeins, and particularly to α-zein are useful in the compositions and methods of this invention.

Additional description of zeins can be found in C. Del-rocio Mejia Ph. D Dissertation “Improving Structure and Function of Maize Zein in Viscoelastic Dough Systems” Purdue University December 2006 and references therein. Additional description of kafirins can be found in Oria M. P., Hamaker, B. R., Axtell, J. D., Huang, C-P. “A highly digestible sorghum mutant cultivar exhibits a unique folded structure of endosperm protein bodies” (2000) Proc. Na'tl Acad Sci (US) 97(10):5065-5070. Additional description of non-wheat prolamins is found in Shewry, P. R. and Tatum, A. S. “The prolamin storage proteins of cereal seeds: structure and evolution” Biochem. J. 1990 (267) 1-12.

Maize zein is particularly useful in the compositions and methods of the invention. However the invention envisions that other non-wheat cereal storage proteins derived from other starchy sources such as, but not limited to, rice, sorghum, millet, oats, etc. can be used pursuant to the invention.

Non-wheat prolamins including those of millet (panicin), rice (oryzenin) and oat (avenin) are each useful in the compositions and methods of this invention. The non-wheat prolamins of rye and barley are less preferred for use in the compositions and methods of this invention. Rice glutelin and oat globulin are also useful in the compositions and methods of this invention.

The invention is especially useful for the manufacture of leavened products, but is not limited thereto as other edible products such as cookies, crackers, cakes, baked goods, cereals, snacks, liquids, nutritional supplements, can benefit therefrom.

In specific embodiments, the invention employs viscoelasticity of a non-wheat prolamin, such as zein, particularly α-zein, when conditioned above its glass transition temperature in a moistened system, and preferably with the addition of a small amount of a co-protein (e.g., casein or elastin) to enhancing the stability of viscoelastic doughs. These combinations and conditioning is believed to allow for formation stable β-sheet structure of the prolamin-co-protein composite in dough that is similar to that which occurs in wheat-based dough. The prolamin, alone or in combination with the co-protein, is, for example, mixed with starch/flour, moistened and warmed to temperatures above the glass transition temperature of the mixture and conditioned at that temperature for a time sufficient to allow the desired protein network to form.

For example, after incubation of a com zein-casein/starch composite at a temperature above the glass transition of the protein (35° C.), its structure changes and allows the formation of a network similar to wheat gluten, which resists stress caused by mixing, and is able suitably to entrap CO₂ from the fermentation process to produce a quality yeast-leavened bread product.

The casein used in the complex may be obtained from any suitable source of substantially intact casein. Examples include sodium caseinate, rennet casein, acid casein, non fat milk solids, and the like.

In other specific embodiments, the invention employs viscoelasticity of a non-wheat prolamin, such as α-zein or α-kafirin, when conditioned above its glass transition temperature in a moistened system, and preferably with the addition of a small amount of a plant co-protein γ-zein or γ-kafirin to enhance the stability of viscoelastic dough. These combinations and conditioning is believed to allow for formation stable β-sheet structure of the prolamin-co-protein composite in dough that is similar to that which occurs in wheat-based dough. The prolamin, alone or in combination with the co-protein, is, for example, mixed with starch/flour, moistened and warmed to temperatures above the glass transition temperature of the mixture and conditioned at that temperature for a time sufficient to allow the desired protein network to form.

One exemplary co-protein that functions in the compositions and methods of this invention is casein. Caseins are part of the milk transport system that delivers protein, calcium, and phosphorus from the mother to the neonate. They are a family of phosphorylated proteins that sequester calcium in the Golgi apparatus of the secretory epithelial cells in the mammary gland, and exist in milk as an aggregate known as casein micelle. In the absence of calcium, the micellar structure dissociates into casein submicelles, consisting of αs1-, αs2-, β-, and κ-casein in the ratio of 1:4:4:1. These proteins correspond to components with approximate molecular weights of 23,000, 25,000, 24,000 and 19,000 Mr, respectively. These proteins have high proline contents and high calculated hydrophobicities. Thus, a number of the hydrophobic amino acids are found on the outer molecular surface of casein monomers. The αs1-, αs2-, β-, and κ-caseins also are phosphorylated on specific serine residues and contain 8, 9 to 11, 5, and 1 phosphates, respectively. Caseins are not considered to be globular proteins, due to their open structures that allow calcium transport and hydration. Historically, caseins were thought to have a random structure, since it was found that they exhibited little α-helix content and did not show evidence of denaturation upon heating.

Although caseins have not been successfully crystallized to date, many techniques have been used to investigate their structure. These studies have attempted to establish secondary structural conformations that range between 13 and 29% for α-helix, 4 and 72% for irregular, and 20 and 30% for β-sheet structures. The apparent lack of consensus regarding the secondary structure in caseins can be explained by caseins rheomorphic nature proposed by Holt, C. and Sawyer, L., 1993 Caseins as rheomorphic proteins: interpretation of primary and secondary structures of the αs1-, β and κ-caseins. J. Chem. Soc. (Faraday Trans.) 1993 89, 2683-2692. According to this study on predicted conformations, caseins are essentially all β-strand type.

However, condensation of these structures into β-sheet conformation is prevented by some of the conserved features of their primary structure near the phosphorylation sites. This was suggested to allow caseins to maintain their mobility and adapt their conformation to the environment. Additionally, evidence of polyproline II conformation in caseins has been recognized. Polyproline II is a left-handed helix with exactly three residues per turn. The majority of these helices are four residues in length, although a very few contain more than nine residues. Proline predominates in this conformation, but glutamine and positively charged residues are also favored. Since regions rich in proline tend to be also rich in glutamine, it has been suggested that glutamine-rich regions share similar properties to proline-rich regions in forming linkages between domains that could induce oligomerization.

Polyproline II helices are more exposed to the molecular surface than other structures, and thus can interact with solvents. α-Casein's long sequences of relatively unconstrained polyproline II have been suggested to impart a plastic (rheomorphic) character to the structure, enabling it to interact with solvents or with other molecules during the micelle assembling process. In summary, caseins appear to have definite secondary structures. The apparent rheomorphic nature of caseins, which allows proteins to form aggregates through protein-protein hydrophobic interactions, suggests that caseins in their native state exist in a type of molten globule state with a significant amount of open, but defined structure.

Any source of casein suitable for human consumption can be employed in the compositions and methods of this invention. The casein may be obtained from any suitable source of substantially intact casein. Examples include sodium caseinate, rennet casein, acid casein, non fat milk solids, and the like. Casein is a major component of non-fat dry milk (NFDM) and of milk protein concentrate. The source of casein may contain lactose and/or whey proteins. In specific embodiments, the source of casein does not contain any substantial levels of lactose (e.g., less than 10% by weight). In other embodiments, the source of casein contains less than 10% by weight, less than 5% by weight, or less than 1% by weight of whey protein. Whey can contain casein, and/or hydrolyzed casein, but is not a preferred source of casein for use in the compositions and methods of this invention.

Another example, co-protein useful in the compositions and methods of this invention is elastin. Elastin is widely distributed in vertebrate tissues. It allows tissues such as skin, vascular walls, or lungs to undergo reversible deformations upon stress. It is synthesized by mesenchymal cells as a soluble precursor, tropoelastin, whose primary transcript undergoes alternative splicing resulting in several protein isoforms. After tropoelastin is released in the extracellular space, it rapidly forms macromolecular fibrils, and most of its lysyl residues are deaminated (Rosenbloom et al., 1993). Upon several reactions, the Lys residues condense into specific cross-links, which cause elastin extreme insolubility. Thus, most investigations have focused on the analysis of the soluble precursor. Tropoelastin is a protein of approximately 70,000 Mr with alternating crosslinking and hydrophobic domains that end with a hydrophilic C-terminus. Cross-linking domains are hydrophilic and rich in Lys and Ala, while the hydrophobic regions are rich is Val, Pro, Ala and Gly, which results in repeats of VPGVG or VGGVG. The hydrophobic regions are though to be responsible for the elasticity in the molecule. The only two Cys residues of the molecule are located in the C-terminal sequence that seemed to be involved in elastin fiber assembly. Circular dichroism, FT-IR, and near infrared spectroscopy studies estimate that elastin has 10% α-helix, 45% β-sheet, and 45% undefined structures. Various models have been proposed to explain elastin behavior including the fact that elastin requires water for elasticity.

Recent investigations have focused on the elucidation of a model with hydrated elastin in which elastin would exhibit a fairly compact amorphous structure with distorted β-strands, fluctuating turns, buried hydrophobic residues, and main chain polar atoms that form hydrogen bonds with water (Li, B., Dagget, V., 2002. Molecular basis for the extensibility of elastin. J. Muscle Res. and Cell Motility 23, 561-573.). This model is based on findings that determined that βII-turns are the most prevalent structures in VPGVG repeats. βII-turn structures were shown to provide elastin of high intra-molecular flexibility. Moreover, hydrated elastin contained 45% short distorted antiparallel β-strands, and non-local hydrogen bonds formed above elastin's glass transition corresponding to distorted β-strands. This is consistent with the requirement for water for the elastic conformation, and with the finding that elastin becomes more organized when temperature is raised above its glass transition.

Any source of elastin suitable for human consumption can be employed in the compositions and methods of this invention.

It is believed that the co-protein functions in the compositions and methods herein to stabilize β-sheet formation in the non-wheat prolamin or other storage protein. This stabilization may occur, for example, by any form of crosslinking of the non-wheat prolamin, for example, through hydrophobic interactions or disulfide cross-links. Additional examples of co-protein suitable for use in the compositions and methods herein are γ-zein and γ-kafirin, which can function to stabilize β-sheet formation in non-wheat prolamin.

The flour compositions and dough of this invention comprise starch or a cereal or tuber flour. In general starch or mixtures of starches or flours from any suitable source can be employed. Wheat is generally not a suitable source for such starches or flours. Suitable starches and flours include, among others, starches and flours of corn, rice, potato, wheat, arrowroot, arracacha, buchwheat, banana, barley, cassava, kudzu, oca, sago, sorghum, sweet potato, taro, yam, and edible bean starch. In specific embodiments, the starch is corn starch, rice starch, potato starch or mixtures thereof. In specific embodiments, the starch is a mixture of corn, rice or potato starch with one or more of arrowroot, tapioca, buckwheat, banana, barley, cassava, kudzu, oca, sago, sorghum starch, sweet potato, taro or yam starch.

When a Markush group or other grouping is used herein, all individual members of the group and all combinations and subcombinations possible of the group are intended to be individually included in the disclosure. Every formulation or combination of components described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein the term “comprising” is intended to encompass “consisting essentially of” and “consisting of”. The term comprising is used to describe compositions and methods herein and in all cases may be replaced with either of “consisting essentially of” or “consisting of.” The invention illustratively described herein suitably may be practiced in the absence of any element or elements, limitation or limitations which is not specifically disclosed herein.

One of ordinary skill in the art will appreciate that ingredients, starting materials, biological materials, reagents, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

All references cited herein are hereby incorporated by reference to the extent that there is no inconsistency with the disclosure of this specification. Some references provided herein are incorporated by reference to provide details concerning sources of starting materials or ingredients, additional starting materials or ingredients, additional methods bread preparation, additional methods of analysis, additional biological materials, and additional uses of the invention.

### THE EXAMPLES

The straight dough bread baking method (Bugusu et al, 2001) is used to evaluate the ability of conditioned protein to form a viscoelastic polymer and be baked into a bread-like product. Starch (87% w/w) and zein (13% w/w) are mixed into a composite and incubated at 35° C. for 24 h before dough formation. The dry composite can also be made out of starch (87%), zein (11.7% w/w) and casein (1.3% w/w). Commercial zein (68% protein, predominantly α-zein) and casein (90% protein) were purchased from Sigma-Aldrich (St. Louis, Mo.). Native normal corn starch was obtained from Tate & Lyle (Decatur, Ill.). The incubation at 35° C. is believed to allow the protein to become flowable and meld with the co-protein, and enables zein or the zein/casein mixture to form a network comparable to wheat gluten that is viscoelastic and builds and retains β-sheet structure, which can resist stress caused by mixing, and which is able to entrap CO₂ from the fermentation and proofing processes. After the conditioning process, the composite is formed into dough in a 100 g Swanson Working mixer (National Mfg. Co., Lincoln, Neb., USA) for 5 min at 35° C. The formed dough is then left to proof for 35 min at 35° C. and baked at 220° C. for 20 min. Alternatively, the dough can be prepared into a leavened loaf with an automatic bread maker. In that case, the formulation has to be adjusted to the capacity of the particular appliance.

The formulation for preparing dough from 100 g of dry composite (starch/cereal protein/co-protein) is as follows:
Dry composite (100 g);
Distilled deionized water (DDW): 46 mL;
Sucrose (20% w/v) and NaCl (5% w/v) solution in purified water (25 mL);
Ammonium phosphate (2% w/v) solution in purified water (5 mL); and
1.4 g dry yeast.

The increase in the volume observed in loaves made of wheat loaf was greater than that of loaves made of zein-starch, but comparable to loaf made of zein-casein-starch.

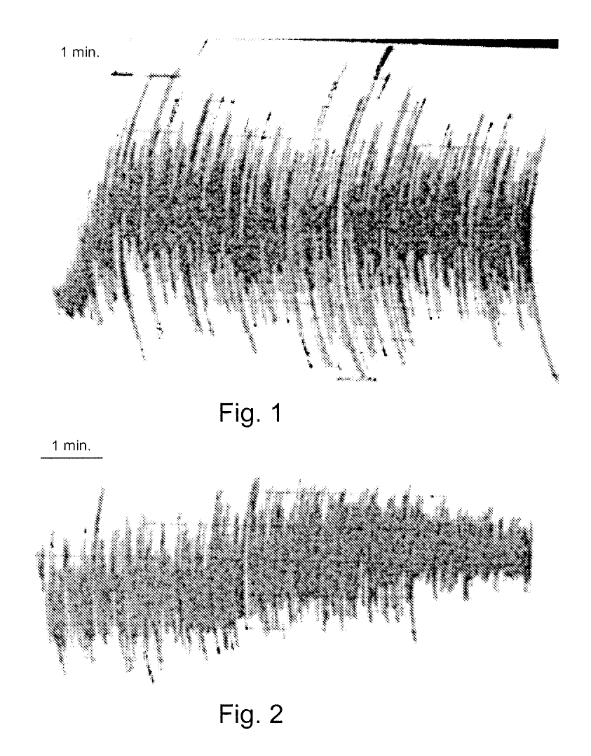

FIGS. 1 and 2 show the similarities and differences in mixograph profiles between wheat dough at 25° C. and the zein-starch and composites at 35° C., respectively. Lower development time and a greater resistance to shear stress (higher mixograph peak) were observed in the zein-starch dough than in the wheat dough. The resistance to stress and the viscoelasticity of the zein system is lost upon removal of stress or at room temperature. However, when casein is added to the system, the resistance to stress and viscoelasticity of the resultant dough is maintained constant after longer periods of time and at room temperature. The addition of casein allows the gluten free dough to maintain its viscoelasticity, and resist CO₂ pressure upon fermentation and proofing. This results in a leavened product upon baking which has quality comparable to that made with wheat flour.

1. A composition for making a gluten-free baked product which comprises a non-wheat starch, flour, or mixture thereof a non-wheat cereal storage protein and a co-protein which stabilizes β-sheet structures of the storage protein.

2. The composition of claim 1 wherein the non-wheat cereal storage protein is a non-wheat cereal prolamin.

3. The composition of claim 2 wherein the prolamin is zein or kafirin.

4. The composition of claim 1 wherein the non-wheat storage protein is α-zein.

5. The composition of claim 1 wherein the non-wheat storage protein is a storage protein of maize, sorghum, millet, rice, or oat.

6. The composition of claim 1 wherein the non-wheat storage protein is selected from the group consisting of a panicin, an oryzenin, an avenin, a rice glutelin, an oat globulin, and mixtures thereof.

7. The composition of claim 1 wherein the non-wheat storage protein is a storage protein of a mutant cultivar in which the protein bodies are disrupted or in which the distribution of storage proteins is distinguishable over corresponding non-mutant cultivars.

8. The composition of claim 1 wherein the protein body mutant is a mutant cultivar of maize or sorghum.

9. The composition of claim 1 wherein the co-protein is casein, elastin or mixtures thereof.

10. The composition of claim 1 wherein the co-protein is γ-zein or γ-kafirin.

11. The composition of claim 1 wherein the non-wheat starch is corn starch.

12. The composition of claim 1 wherein the non-wheat starch or flour is selected from the group consisting of starches or flours of maize, sorghum, millet, rice, oat and mixtures thereof.

13. The composition of claim 1 wherein the co-protein is present at a level of 0.1 to 1% by weight of the flour.

14. The composition of claim 1 wherein the non-wheat cereal storage protein is present at a level of 5% to about 15% by weight of the composition.

15. A dough prepared from the composition of claim 1.

16. A leavened dough prepared from the composition of claim 1.

17. A conditioned protein ingredient for preparation of dough which comprises a non-wheat cereal storage protein and a co-protein which stabilizes β-sheet structures of the storage protein.

18. The ingredient of claim 17 wherein the non-wheat cereal storage protein is a non-wheat cereal prolamin.

19. The ingredient of claim 17 wherein the prolamin is zein or kafirin.

20. The ingredient of claim 17 wherein the non-wheat storage protein is α-zein.

21. The ingredient of claim 17 wherein the non-wheat storage protein is a storage protein of maize, sorghum, millet, rice, or oat.

22. The ingredient of claim 17 wherein the non-wheat storage protein is selected from the group consisting of a panicin, an oryzenin, an avenin, a rice glutelin, an oat globulin, and mixtures thereof.

23. The conditioned protein ingredient of claim 17 which is conditioned at temperatures above the glass transition temperature of the storage protein for 12-36 hours.

24. A dough prepared from the conditioned protein ingredient of claim 17.

25. A baked product or leavened baked product made from the dough of claim 24.

26. A method for making a baked product which comprises the steps of:
a. preparing a conditioned protein ingredient by combining a non-wheat cereal storage protein with a co-protein which stabilizes β-sheet formation in the storage protein during processing;
b. preparing a dough from the conditioned protein ingredient; and
c. preparing the baked product from the dough.

27. The method of claim 26 wherein the conditioned protein ingredient comprises zein, kafirin, casein or elastin.

28. The method of claim 26 wherein the dough is leavened.

29. The method of claim 26 wherein the protein ingredient is conditioned at a temperature of 35° to 50° C.

30. The method of claim 26 wherein the dough is prepared by combining starch and the conditioned protein ingredient with water or other liquid.

31. The method claim 26 wherein the non-wheat storage protein is a non-wheat prolamin.

32. The method of claim 26 wherein the co-protein is selected from the group consisting of casein, elastin, γ-zein, γ-kafirin or mixtures thereof.
